(19) United States
(12) Patent Application Publication
(10) Pub. No.: US 2023/0236370 A1
(43) Pub. Date: Jul. 27, 2023

(54) OPTICAL DEVICE AND OPTICAL SYSTEM

(71) Applicant: National Institute of Advanced Industrial Science and Technology, Tokyo (JP)

(72) Inventors: Takeru AMANO, Ibaraki (JP); Akihiro NORIKI, Ibaraki (JP); Satoshi SUDA, Ibaraki (JP)

(21) Appl. No.: 18/119,101

(22) Filed: Mar. 8, 2023

Related U.S. Application Data
(63) Continuation-in-part of application No. PCT/JP2021/025745, filed on Jul. 8, 2021.

(30) Foreign Application Priority Data
Sep. 15, 2020 (JP) 2020-154578

(51) Int. Cl. G02B 6/42

(52) U.S. Cl. CPC G02B 6/4231

(57) ABSTRACT

A first optical device includes a substrate, a first optical waveguide provided to the substrate, and a first connector attached to the substrate. At least a portion of the substrate is positioned outside the first connector forwardly of light emitted from one end of the first optical waveguide.

### CROSS-REFERENCE TO RELATED APPLICATIONS

This application is a bypass continuation-in-part application of International PCT Application No. PCT/JP2021/025745, filed on Jul. 8, 2021, which claims priority to Japanese Patent Application No. 2020-154578, filed on Sep. 15, 2020, which are incorporated by reference herein in their entirety.

### TECHNICAL FIELD

The present invention relates to an optical device and an optical system.

### BACKGROUND ART

In recent years, optical systems have been developed in which a first optical device including a substrate provided with a first optical waveguide such as a polymer waveguide and a second optical device including a second optical waveguide such as an optical fiber are interconnected. As described in Patent Document 1, for example, a first connector of the first optical device and a second connector of the second optical device interconnected to each other allows for positioning of the first optical device and the second optical device, thereby enabling transmitting and receiving of optical signals between the first optical waveguide and the second optical waveguide.

### SUMMARY

The first connector and the second connector may be caused to push against each other to position the first optical device and the second optical device. In this case, however, misalignment between the first optical waveguide and the second optical waveguide may occur due to displacement of the first connector from the substrate caused by a pressing force received by the first connector from the second connector.

An example of an object of the present invention is to reduce the misalignment between two optically coupled optical waveguides. Other objects of the present invention will become apparent from the description herein.

An aspect of the present invention is an optical device including: a substrate; an optical waveguide provided to the substrate; and a connector attached to the substrate, wherein at least a portion of the substrate is positioned outside the connector forwardly of light emitted from one end of the optical waveguide.

Another aspect of the present invention is an optical system including: a first optical device including a substrate, a first optical waveguide provided to the substrate, and a first connector attached to the substrate; and a second optical device including a second optical waveguide optically coupled to the first optical waveguide, and a second connector attached to the second optical waveguide, wherein at least a portion of the substrate is positioned outside the first connector toward a side on which the second connector is positioned.

The above aspects of the present invention can reduce the misalignment between two optically coupled optical waveguides.

### BRIEF DESCRIPTION OF THE DRAWINGS

FIG. 1 is a top view of an optical system according to an embodiment.

FIG. 2 is an A-A′ cross sectional view of FIG. 1.

FIG. 3 is a B-B′ cross sectional view of FIG. 1.

FIG. 4 is a diagram illustrating a first variation of FIG. 2.

FIG. 5 is a diagram illustrating a second variation of FIG. 2.

### DETAILED DESCRIPTION

An embodiment and variations of the present invention will be described below by using drawings. Note that in every drawing, similar components are given similar signs, and description thereof is omitted as appropriate.

Unless otherwise noted, ordinal numerals such as “first,” “second,” and “third” are herein given for simply distinguishing between components given with similar names and do not mean a specific characteristic (such as an order or importance).

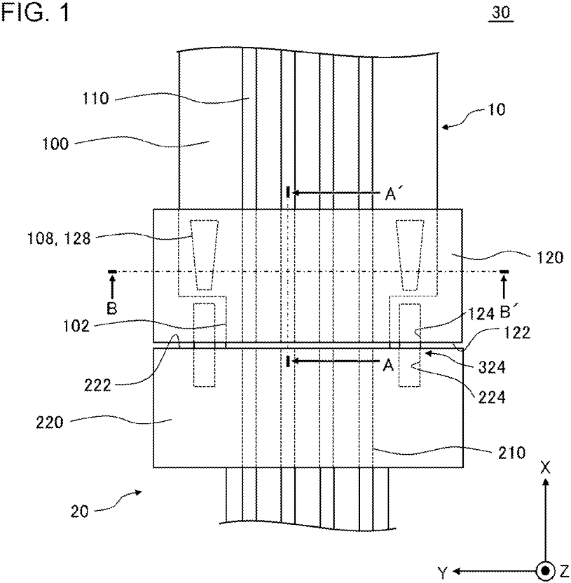

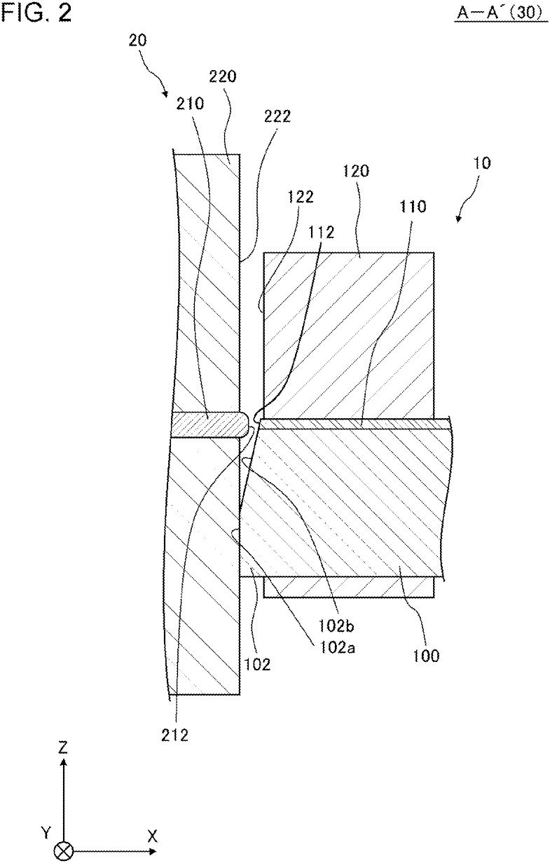

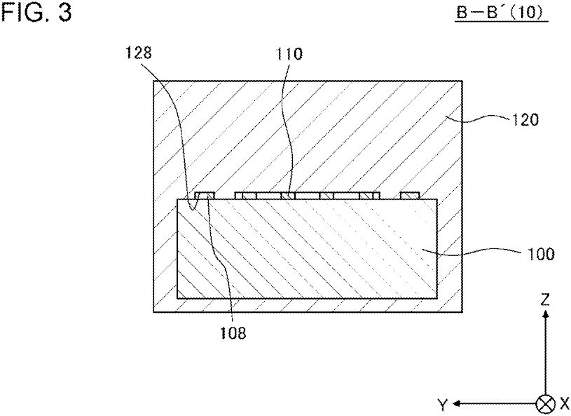

FIG. 1 is a top view of an optical system 30 according to an embodiment. FIG. 2 is an A-A′ cross sectional view of FIG. 1. FIG. 3 is a B-B′ cross sectional view of FIG. 1.

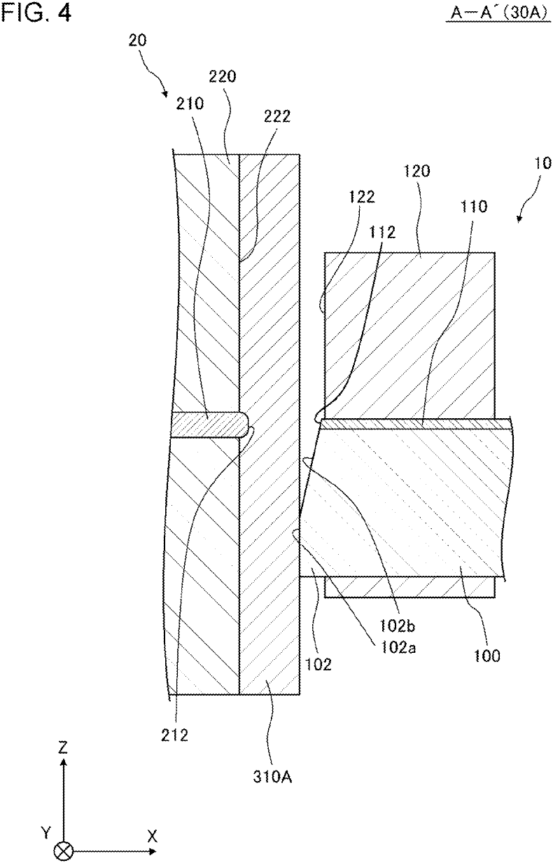

In FIG. 1 to FIG. 3, a first direction X is a direction parallel to a horizontal direction perpendicular to a vertical direction. A second direction Y is a direction parallel to the horizontal direction and is orthogonal to the first direction X. A third direction Z is a direction parallel to the vertical direction. Arrows representing the first direction X, the second direction Y, or the third direction Z indicate that a direction from the start toward the tip of the arrow is a positive direction of the direction represented by the arrow, and that a direction from the tip toward the start of the arrow is a negative direction of the direction represented by the arrow. White circles marked with a black dot representing the first direction X, the second direction Y, or the third direction Z indicate that a direction from the back to the front of the page is a positive direction of the direction represented by the arrow, and that a direction from the front to the back of the page is a negative direction of the direction represented by the arrow. White circle marked with X representing the first direction X, the second direction Y, or the third direction Z indicate that the direction from the front to the back of the page is a positive direction of the direction represented by the arrow, and that the direction from the back to the front of the page is a negative direction of the direction represented by the arrow. The same applies to FIG. 4 to be described later.

According to the present embodiment, the positive direction of the first direction X is a direction from a second optical device 20 described later toward a first optical device 10, and the negative direction of the first direction X is a direction from the first optical device 10 toward the second optical device 20. The positive direction of the third direction Z is the vertical upward direction, and the negative direction of the third direction Z is the vertical downward direction. Note that a mode of use of the optical system 30 is not limited to the mode according to the present embodiment. For example, the optical system 30 may be used such that the third direction Z is a direction different from the vertical direction, such as the horizontal direction or a direction diagonal to the vertical direction.

The optical system 30 includes the first optical device 10 and the second optical device 20. The first optical device 10 includes a substrate 100, a plurality of first optical waveguides 110, and a first connector 120. The second optical device 20 includes a plurality of second optical waveguides 210 and a second connector 220.

The substrate 100 is made of a semiconductor such as silicon, an organic material such as resin, ceramics or the like, for example. The substrate 100 has a thickness in a direction parallel to the third direction Z. The substrate 100 includes a protruding portion 102 extending toward the negative direction of the first direction X.

Each first optical waveguide 110 is made of an organic material such as a polymer, a semiconductor such as silicon or a compound semiconductor, quartz or the like, for example. The plurality of first optical waveguides 110 extend in parallel to the first direction X. Each first optical waveguide 110 is provided on the upper surface of the substrate 100. Note that each first optical waveguide 110 may be provided at other position in the substrate 100, such as inside the substrate 100, instead of on the upper surface of the substrate 100. The number of first optical waveguides 110 provided to the first optical device 10 may be only one.

The first connector 120 is attached to the substrate 100. Specifically, as illustrated in FIG. 3, the first connector 120 is physically coupled to the substrate 100 by a projecting portion 108 provided on the upper surface of the substrate 100 being fit into a recessed portion 128 provided on the first connector 120. The projecting portion 108 is made of the same material as the material constituting the first optical waveguide 110, for example. In the present embodiment, two projecting portions 108 are provided on both sides of the plurality of first optical waveguides 110 in the second direction Y. Note that the position where the projecting portion 108 is provided is not limited to the example according to the present embodiment.

Each second optical waveguide 210 is an optical fiber, for example. The plurality of second optical waveguides 210 extend in parallel to the first direction X. Note that the number of second optical waveguides 210 provided to the second optical device 20 may be only one.

A first end 112 of the first optical waveguide 110 on the negative direction side in the first direction X and a second end 212 of the second optical waveguide 210 on the positive direction side in the first direction X face each other. In the present embodiment, a gap exists between the first end 112 of the first optical waveguide 110 and the second end 212 of the second optical waveguide 210. Light emitted from the first end 112 of the first optical waveguide 110 travels in the negative direction of the first direction X and is incident on the second end 212 of the second optical waveguide 210. Light emitted from the second end 212 of the second optical waveguide 210 travels in the positive direction of the first direction X and is incident on the first end 112 of the first optical waveguide 110. Thus, signals are transmitted and received between the first optical waveguide 110 and the second optical waveguide 210, and the first optical waveguide 110 and the second optical waveguide 210 are optically coupled.

The second connector 220 is provided at end portions of the plurality of second optical waveguides 210 on the positive direction side in the first direction X. The second connector 220 is physically coupled to the first connector 120. Specifically, one end and the other end of a pin 324 extending in the first direction X are inserted into a first guide hole 124 provided on a third side surface 122 of the first connector 120 on the negative direction side in the first direction X and a second guide hole 224 provided on a fourth side surface 222 of the second connector 220 on the positive direction side in the first direction X, respectively. In the present embodiment, two pins 324 are provided on both sides of the protruding portion 102 of the substrate 100 in the second direction Y. The two pins 324 are lined with the two projecting portions 108 of the substrate 100 and the two recessed portions 128 of the first connector 120 in the first direction X. Note that the position where the pin 324 is provided is not limited to the example according to the present embodiment.

As illustrated in FIG. 2, at least a portion of the substrate 100 is positioned outside the first connector 120 forwardly of light emitted from the first end 112 of the first optical waveguide 110, that is, toward a side on which the second connector 220 is positioned. Specifically, the surface of the protruding portion 102 of the substrate 100 on the negative direction side in the first direction X includes a first side surface 102a protruding in the negative direction of the first direction X relative to the third side surface 122 of the first connector 120 on the negative direction side in the first direction X. In positioning the first optical waveguide 110 and the second optical waveguide 210, the first side surface 102a of the substrate 100 pushes against the fourth side surface 222 of the second connector 220 on the positive direction side in the first direction X. In this case, there is no need to cause the third side surface 122 of the first connector 120 and the fourth side surface 222 of the second connector 220 to push against each other. If the third side surface 122 of the first connector 120 and the fourth side surface 222 of the second connector 220 are caused to push against each other in positioning the first optical waveguide 110 and the second optical waveguide 210, the first connector 120 may be displaced from the substrate 100 by a pressing force received by the first connector 120 from the second connector 220, and misalignment between the first optical waveguide 110 and the second optical waveguide 210 may occur. Also, when the projecting portion 108 is made of a relatively low-strength material such as a polymer, the projecting portion 108 may be broken by the pressing force received by the first connector 120 from the second connector 220. The present embodiment, on the other hand, can reduce the misalignment between the first optical waveguide 110 and the second optical waveguide 210 caused by the pressing force received by the first connector 120 from the second connector 220.

As illustrated in FIG. 2, the first side surface 102a of the substrate 100 is positioned outside the first end 112 of the first optical waveguide 110 forwardly of light emitted from the first end 112 of the first optical waveguide 110. The first end 112 of the first optical waveguide 110 can be accordingly spaced apart from the second end 212 of the second optical waveguide 210. The first end 112 of the first optical waveguide 110 and the second end 212 of the second optical waveguide 210 spaced apart from each other can provide greater suppression of the misalignment between the first optical waveguide 110 and the second optical waveguide 210 than the first end 112 of the first optical waveguide 110 and the second end 212 of the second optical waveguide 210 in contact with each other. The distance between the first end 112 of the first optical waveguide 110 and the second end 212 of the second optical waveguide 210 can be adjusted according to a distance by which the first side surface 102a of the substrate 100 protrudes relative to the first end 112 of the first optical waveguide 110 toward the negative direction of the first direction X.

A surface of the protruding portion 102 of the substrate 100 on the negative direction side in the first direction X includes a second side surface 102b positioned on the positive direction side of the first side surface 102a in the first direction X. The second side surface 102b of the substrate 100, that is, a portion of the substrate 100 from the first end 112 of the first optical waveguide 110 to the first side surface 102a is flush with the first end 112 of the first optical waveguide 110. The shapes of the second side surface 102b of the substrate 100 and the first end 112 of the first optical waveguide 110 can be formed, for example, by dicing cut of the substrate 100 and the first optical waveguide 110. This allows for relatively inexpensive formation of the shapes of the second side surface 102b of the substrate 100 and the first end 112 of the first optical waveguide 110. The inclination of the first end 112 of the first optical waveguide 110 relative to the third direction Z can be adjusted by adjusting the angle of the dicing cut.

The first end 112 and the second side surface 102b are diagonally inclined relative to a direction perpendicular to the emission direction of light emitted from the first end 112 of the first optical waveguide 110. Specifically, the first end 112 and the second side surface 102b are inclined toward the negative direction of the first direction X toward the negative direction of the third direction Z. In this case, multiple reflection of light between the first end 112 of the first optical waveguide 110 and the second end 212 of the second optical waveguide 210 can be suppressed as compared to a case where the first end 112 is parallel to the third direction Z. The present embodiment can therefore reduce transmission noise as compared to the case where the first end 112 is parallel to the third direction Z. The present embodiment especially eliminates the need for covering the first end 112 of the first optical waveguide 110 with an anti-reflective (AR) coating.

FIG. 4 is a diagram illustrating a first variation of FIG. 2. An optical system 30A according to this variation is similar to the optical system 30 according to the embodiment except for the following point.

The optical system 30A includes a film 310A positioned between the first optical device 10 and the second optical device 20. In positioning the first optical waveguide 110 and the second optical waveguide 210, the side surface 102a of the substrate 100 and the fourth side surface 222 of the second connector 220 push against each other with the film 310A therebetween. The distance between the first end 112 of the first optical waveguide 110 and the second end 212 of the second optical waveguide 210 can be adjusted by adjusting the thickness of the film 310A in a direction parallel to the first direction X.

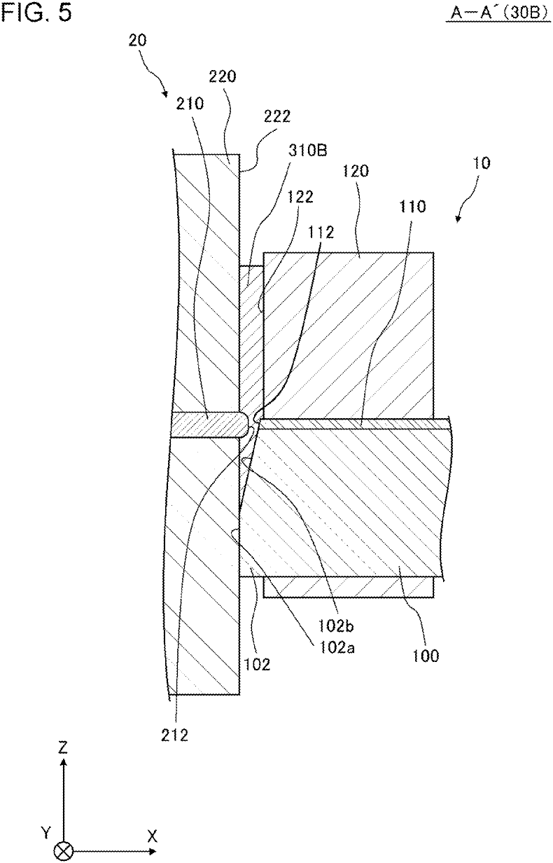

FIG. 5 is a diagram illustrating a second variation of FIG. 2. An optical system 30B according to this variation is similar to the optical system 30 according to the embodiment except for the following point.

The optical system 30B includes a refractive index matching material 310B embedded in a gap between the first optical device 10 and the second optical device 20. Examples of the refractive index matching material 310B include matching oil, matching gel and the like. The refractive index matching material 310B existing in a region between the first end 112 of the first optical waveguide 110 and the second end 212 of the second optical waveguide 210 can reduce the refractive index difference between the first end 112 and a region in contact with the first end 112, that is, the refractive index matching material 310B, and the refractive index difference between the second end 212 and a region in contact with the second end 212, that is, the refractive index matching material 310B, as compared to a case where the region between the first end 112 of the first optical waveguide 110 and the second end 212 of the second optical waveguide 210 is air. The refractive index matching material 310B existing in the region between the first end 112 and the second end 212 can accordingly reduce an effect caused by the refractive index difference between the first end 112 and the region in contact with the first end 112, and an effect caused by the refractive index difference between the second end 212 and the region in contact with the second end 212, as compared to the case where the region between the first end 112 and the second end 212 is air.

While the embodiment and variations of the present invention have been described above with reference to the drawings, the embodiment and the variations are exemplifications of the present invention, and various configurations other than those described above may be employed.

For example, the second side surface 102b of the substrate 100 is diagonally inclined relative to the side surface 102a of the substrate 100. The second side surface 102b of the substrate 100 may be however parallel to the side surface 102a of the substrate 100.

This application claims priority based on Japanese Patent Application No. 2020-154578 filed on Sep. 15, 2020, the disclosure of which is hereby incorporated by reference thereto in its entirety.

REFERENCE SIGNS LIST

| | |
|---|---|
| 10 | First optical device |
| 20 | Second optical device |
| 30 | Optical system |
| 30A | Optical system |
| 30B | Optical system |
| 100 | Substrate |
| 102 | Protruding portion |
| 102 a | First side surface |
| 102 b | Second side surface |
| 108 | Projecting portion |
| 110 | First optical waveguide |
| 112 | First end |
| 120 | First connector |
| 122 | Third side surface |
| 124 | First guide hole |
| 128 | Recessed portion |
| 210 | Second optical waveguide |
| 212 | Second end |
| 220 | Second connector |
| 222 | Fourth side surface |
| 224 | Second guide hole |
| 310A | Film |
| 310B | Refractive index matching material |
| 324 | Pin |
| X | First direction |
| Y | Second direction |
| Z | Third direction |

What is claimed is:

1. An optical device comprising:
a substrate;
an optical waveguide provided to the substrate and extending in a first direction, the optical waveguide being configured to optically couple to another optical waveguide; and
a connector attached to the substrate, wherein:
the substrate includes a first side surface protruding toward a side on which another connector attached to the other optical waveguide is positioned, and
the first side surface of the substrate is perpendicular to the first direction and is configured to push against the other connector.

2. The optical device according to claim 1, wherein
the optical waveguide includes a first end facing another end of the other optical waveguide;
the first side surface of the substrate is positioned outside the first end of the optical waveguide toward the side on which the other connector is positioned.

3. The optical device according to claim 2, wherein
the first end of the optical waveguide is diagonally inclined relative to a direction perpendicular to the first direction.

4. The optical device according to claim 2, wherein
the substrate includes a second side surface from the first end of the optical waveguide to the first side surface,
the second side surface of the substrate is flush with the first end of the optical waveguide.

5. An optical system comprising:
a first optical device including a substrate, a first optical waveguide provided to the substrate and extending in a first direction, and a first connector attached to the substrate; and
a second optical device including a second optical waveguide optically coupled to the first optical waveguide and a second connector attached to the second optical waveguide, wherein
the substrate includes a first side surface protruding toward a side on which the second connector is positioned, and
the first side surface of the substrate is perpendicular to the first direction and pushes against the second connector.

6. The optical system according to claim 5, wherein
the first optical waveguide includes a first end facing a second end of the second optical waveguide;
the first side surface of the substrate is positioned outside the first end of the first optical waveguide toward the side on which the first connector is positioned.

7. The optical system according to claim 6, wherein
the first end of the first optical waveguide is diagonally inclined relative to a direction perpendicular to the first direction.

8. The optical system according to claim 6, wherein
the substrate includes a second side surface from the first end of the first optical waveguide to the first side surface,
the second side surface of the substrate is flush with the first end of the first optical waveguide.

9. The optical device according to claim 1, further comprising a film at least partially positioned between the first side surface of the substrate and the other connector.

10. The optical system according to claim 5, further comprising a film at least partially positioned between the first side surface of the substrate and the second connector.
